(19) United States
(12) Patent Application Publication
(10) Pub. No.: US 2023/0014659 A1
(43) Pub. Date: Jan. 19, 2023

(54) OPTICAL CONNECTOR ASSEMBLIES FOR LOW LATENCY PATCHCORDS

(71) Applicant: OFS Fitel, LLC, Norcross, GA (US)

(72) Inventors: Matt Corrado, Flemington, NJ (US); Tristan Kremp, Somerset, NJ (US); Brian Mangan, Hopewell, NJ (US); Kelvin B. Bradley, Lawrenceville, GA (US); Thomas Stafford, Buford, GA (US); Yue Liang, Johns Creek, GA (US); Brian Savran, Avon, CT (US)

(73) Assignee: OFS Fitel, LLC, Norcross, GA (US)

(21) Appl. No.: 17/785,176

(22) PCT Filed: Dec. 16, 2020
(86) PCT No.: PCT/US20/65392

§ 371 Date: Jun. 14, 2022

Related U.S. Application Data
(60) Provisional application No. 62/948,372, filed on Dec. 16, 2019.

(51) Int. Cl. G02B 6/255; G02B 6/02

(52) U.S. Cl. CPC G02B 6/2556; G02B 6/02042; G02B 6/2551

(57) ABSTRACT

Described herein are systems, methods, and articles of manufacture for reducing coupling loss between optical fibers, more particularly, to reducing coupling loss between a hollow-core optical fiber (HCF) and another fiber, such as solid core fibers (SCF), through the use of mismatched mode field diameter (MFD) and optical connector assemblies for low latency patchcords. According to one embodiment, an article is configured to reduce a coupling loss between multiple optical fibers, wherein the article includes an HCF supporting the propagation of a first mode and an SCF coupled to the HCF. According to a further embodiment, a method is described for reducing the coupling loss or splicing loss between optical fibers, such as an exemplary HCF and a solid core SMF. These exemplary articles and methods may include coupling/splicing an exemplary HCF to an exemplary SMF with significantly smaller MFD as well as a splice-on-connector (SOC) assembly including a bridge fiber spliced between the HCF and the SCF, wherein the bridge fiber has a third MFD that is greater than the second MFD and smaller than the first MFD. Additional embodiments may feature a SCF having a second MFD at the proximal end and a third MFD at the distal end, wherein the second MFD is greater than the third MFD, and the third MFD is no greater than 90% of the first MFD of the HCF.

### CROSS-REFERENCE TO RELATED APPLICATIONS

This application claims the benefit of U.S. Provisional Application No. 62/948,372, filed Dec. 16, 2019, and herein incorporated by reference.

### TECHNICAL FIELD

Described herein are systems, methods, and articles of manufacture for reducing coupling loss between optical fibers, more particularly, to reducing coupling loss between a hollow-core optical fiber (HCF) and another fiber, such as a solid core fiber (SCF), through the use of mode field diameter (MFD) mismatch. Further described herein are systems, methods, and articles of manufacture for optical connector assemblies for low latency patchcords.

### BACKGROUND OF THE INVENTION

Hollow-core optical fiber is a powerful technology platform offering breakthrough performance improvements in sensing, communications, higher-power optical pulse delivery, and the like. Indeed, since its latency is almost equal to the propagation of an optical wave in a vacuum, the hollow-core optical fiber offers an attractive solution for data centers, high-frequency stock trading communication links, distributed computing environments, high-performance computing, etc. In the stock trading application, for example, the hollow-core optical fiber is contemplated as allowing for decreased data transmission times between trading computers, enabling trading programs to complete programmed trading transactions more quickly.

A hollow core fiber is defined here as any fiber that has a core that is not solid, such as a hollow core that can be a vacuum or filled with a gas, such as air, hydrogen or noble gases such as Argon. In this disclosure, a hollow core fiber with a photonic bandgap cladding is exemplified but the coupling loss between any hollow core fiber (e.g., anti-resonant ring HCF, nested anti-resonant nodeless HCF, revolver HCF, conjoined tube HCF, Kagome HCF, etc.) can be reduced by the methods explained herein. Typically, hollow core fibers have a larger core diameter than standard solid core optical fibers to reduce the amount of light that overlaps with the air/glass interfaces at the edge of the core that is the dominant cause of loss in the fiber.

In an optical link, latency is the time between sending and receiving a signal. In recent years, the need for low latency in optical networks has become critical, e.g., to support high-frequency trading and error checking within data centers. HCF offers not only extremely low latency but also temperature stability, low nonlinearities and radiation hardness. In an optical setup or system that takes advantage of the desirable properties of hollow-core fiber such as low latency, temperature independence, low nonlinearities, radiation hardness, etc., the HCF usually needs to be coupled at one or several points to standard optical components that are designed for standard commercially available SCF, typically solid-core single-mode fiber (SMF). Thus, a need remains in the art for minimizing the coupling loss of these connections or splices, as these connections are often crucial for the best possible performance of the system. There are typically two main contributors to the coupling loss: 1) Fresnel back reflections at air-glass interfaces; and 2) a possible mode-field/mode-shape mismatch between the HCF and SCF. Since the transverse profile of the fundamental modes of the HCF can differ substantially from the fundamental mode of an SMF, it is unclear what is the best MFD ratio in both fibers to achieve a minimum coupling loss between these modes.

### SUMMARY OF THE INVENTION

The present invention addresses the needs in the art and is directed to reducing the coupling or splicing loss in connections that include a hollow-core optical fiber. For instance, the coupling loss or splicing loss between an HCF and an SMF may be minimized in one direction by choosing an SMF with an MFD that is significantly smaller than the MFD of the HCF. According to the exemplary embodiments of the present invention, it may be advantageous to add a short section of a third fiber between the SCF and the HCF to minimize the overall coupling loss. This additional fiber may be referred to as a “bridge” fiber or mode field adaptation fiber (MFAF), whose shape may or may not vary along its length.

Novel optical connector assemblies for terminating HCFs are presented herein to produce low latency “patchcords,” or bridge fibers. If the MFD of the SCF is too small, or if the MFD of the HCF is too big, to achieve the minimum loss, one or more bridge fibers may be spliced or connectorized between the SCF and the HCF to reduce the loss. The shape of a bridge fiber may be constant or vary along its length, e.g., by using a thermally expanded core (TEC) or small form factor (SFF) fiber.

In accordance with one or more embodiments of the present invention, an article of manufacture is described herein that is configured to reduce a coupling loss between multiple optical fibers, wherein the article of manufacture includes an HCF supporting the propagation of a first mode and an SCF coupled to the HCF. More specifically, exemplary embodiments described herein relate to reducing coupling loss between HCFs and SCFs by mode field mismatch and optical connector assemblies for low latency patchcords.

An exemplary embodiment of the present invention takes the form of an article of manufacture configured to reduce a coupling loss between multiple optical fibers, including a HCF having a first MFD, a SCF having a second MFD that is no greater than 90% of the first MFD, and a splice-on-connector (SOC) assembly including a bridge fiber spliced between the HCF and the SCF, wherein the bridge fiber has a third MFD that is greater than the second MFD and smaller than the first MFD.

A further exemplary embodiment of the present invention takes the form of an article of manufacture configured to reduce a coupling loss between multiple optical fibers, including an HCF having a first MFD, and an SCF having a proximal end spliced to the HCF and a distal end, the SCF further having a second MFD at the proximal end and a third MFD at the distal end, wherein the second MFD is greater than the third MFD, and the third MFD is no greater than 90% of the first MFD.

A further exemplary embodiment of the present invention takes the form of a method configured to reduce a coupling loss between multiple optical fibers, the method including coupling an HCF having a first MFD to an SCF fiber, wherein the SCF has a proximal end spliced to the HCF and a distal end, the SCF further having a second MFD at the proximal end and a third MFD at the distal end, wherein the second MFD is greater than the third MFD, and the third MFD is no greater than 90% of the first MFD.

Other and further embodiments and aspects of the present invention will become apparent during the course of the following discussion and by reference to the accompanying drawings.

### BRIEF DESCRIPTION OF THE DRAWINGS

Referring now to the drawings:

FIG. 1 illustrates an HCF with one large center core and two smaller outer shunt cores;

FIG. 2 is a diagram depicting the fundamental mode in an exemplary 19-cell HCF with 6 outer cores (shunts) in accordance with one embodiment of the present invention;

FIG. 3A illustrates the wavelength dependence of the modal properties of the exemplary HCF in FIG. 2 based on mode mismatch contributions to splice loss for various SMF MFD;

FIG. 3B illustrates the wavelength dependence of the modal properties of the exemplary HCF in FIG. 2 based on the MFD of the exemplary HCF in FIG. 2;

FIG. 4 illustrates the relationship of the optimum MFD ratio vs. normalized core size of two exemplary HCFs in accordance with one embodiment of the present invention;

FIG. 5 illustrates the relationship of the optimum SMF MFD vs. HCF core diameter of two exemplary HCFs in accordance with one embodiment of the present invention;

FIG. 6 is an exploded view of an exemplary assembly for an HCF termination using a splice-on connector (SOC) in accordance with one embodiment of the present invention;

FIG. 7 shows a close-up of an SOC plug assembly in accordance with one embodiment of the present invention;

FIG. 8 shows an exploded view of an SOC plug assembly in accordance with one embodiment of the present invention;

FIG. 9 shows an SCF-to-ultra-large area fiber (ULA)-to-HCF configuration after SOC installation in accordance with one embodiment of the present invention;

FIG. 10 shows an SCF-to-ULA-to-HCF configuration after SOC installation with SCF-to-ULA splice located inside ferrule in accordance with one embodiment of the present invention;

FIG. 11 shows an HCF-to-thermally expanded core (TEC) fiber configuration after SOC installation in accordance with one embodiment of the present invention; and

FIG. 12 shows an HCF-to-small-form-factor fiber (SFF) fiber configuration after SOC installation in accordance with one embodiment of the present invention.

### DETAILED DESCRIPTION

As will be discussed in detail below, the present invention relates to assessing the properties of various types of couplings and splices between hollow-core optical fibers and other fibers to minimize the coupling loss. For example, the transmission of optical signal light along an “air” core (as is the case for various configurations of hollow-core fiber) provides for transmission speeds that are about 50% greater than that associated with standard silica core optical fibers, corresponding to an approximately one third reduction in latency. As mentioned above, this feature has particular applications to high-frequency trading companies, which rely on low latency communication links. Low latency also has applications in datacenter/supercomputer applications, where hundreds of kilometers of optical cables are used to interconnect thousands of servers. As discussed above, one embodiment of the invention allows for the coupling loss or splicing loss between an HCF and an SMF to be minimized by choosing an SMF with an MFD that is significantly smaller than the MFD of the HCF. In this disclosure, the term MFD may refer to the fundamental mode. Furthermore, according to a further embodiment of the present invention, it may be advantageous to add a short section of a third fiber, referred to as a “bridge” fiber or mode field adaptation fiber (MFAF) here, between the SMF and the HCF to minimize the overall coupling loss.

To take full advantage of the low-latency characteristics provided by HCF, excess fiber length should be avoided to minimize the optical path length during deployment. Furthermore, slack loops and coils at splice points should also be avoided. As such, the fibers may be deployed to a minimal prescribed length, using fusing splicing methods, which can involve splicing the HCF to an SCF. However, these splicing methods alone may not result in a very robust assembly (e.g., 250 μm non-buffered or 900 μm buffered fibers fusion-spliced together and placed within a splice protector). According to the exemplary embodiments described herein, a more robust assembly can be realized via connectorization of the hollow-core fibers.

One technique for providing reliable connectorization of optical fibers requires that the fibers be epoxied into a polymeric, glass, or ceramic ferrule and subsequently cleaved and polished. While this technique can be used for SCF, it is generally unsuitable for HCF since the process would adversely affect the transmission characteristics of the fiber's photonic-band-gap microstructure by either damaging it or filling it with epoxy and/or debris. Therefore, to perform reliable connectorization, the HCF may be fusion-spliced to an SCF, which can then be reliably connectorized using conventional procedures. However, to minimize latency, the exemplary connectors should be installed onsite once the cable containing the HCF has been deployed in the ideal route. Also, as mentioned above, fusion splicing an HCF directly to an SCF (e.g., to standard single-mode solid-core fiber) may result in high insertion loss, mainly due to MFD mismatch. As such, pre-polished connectors, specifically configured to quickly terminate the HCF while providing improved loss performance, splice protection, and cable strain relief, may be utilized.

In a logarithmic (decibel) scale, the total coupling or splicing loss α^{(dB)} between an HCF and an SMF is the sum of two terms according to:

$${α}^{( dB )} = {\underbrace{\begin{matrix}- 10 {log}_{10} & ( 1 - {( \frac{{n}_{SMF}^{eff} - {n}_{HCF}^{eff}}{{n}_{SMF}^{eff} + {n}_{HCF}^{eff}} )}^{2} )\end{matrix}}}_{= : {α}_{Fresnel}^{( dB )}} {\underbrace{\begin{matrix}- 10 {log}_{10} & ( {max}_{MFD} {max}_{{x}_{0} , {y}_{0}} {max}_{φ ∈ [ 0 , 2 π )} \frac{{\vert ( {E}_{SMF} , {E}_{HCF} ) \vert}^{2}}{( {E}_{SMF} , {E}_{SMF} ) ( {E}_{HCF} , {E}_{HCF} )} )\end{matrix}}}_{= : {α}_{mode mismatch}^{( dB )}} .$$

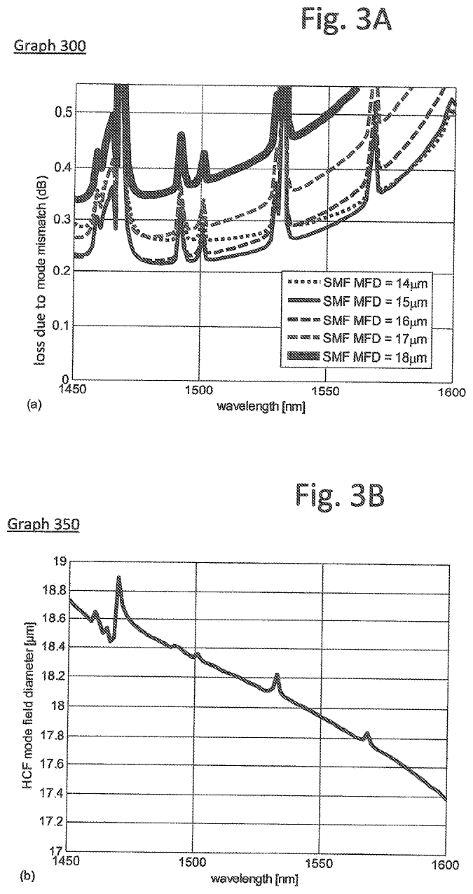

The first term α_{Fresnel}^{(dB)} is the unavoidable Fresnel reflection because of the substantially different effective indices. At a wavelength of 1550 nm, there may typically be n_{SMF}^{eff}=1.45 and n_{HCF}^{eff}=1, leading to α_{Fresnel}^{(dB)}=0.15 dB. To avoid that the Fresnel-reflected light is backward-propagated along the fiber, which would cause unwanted noise in the system, the splice can be angled relative to the fiber cross section. The second term α_{mode mismatch}^{(dB)} (see FIG. 3A) is due to the mismatch of the fundamental modes in the two fibers, approximated by transverse overlap integrals of the (electrical) fields E_{HCF} in the HCF and E_{SMF} in the SMF, using the notation of the symmetric sesquilinear form:

(U,V):=∫_{A}(Uₓ(x,y)Vₓ*(x,y)+U_{y}(x,y)V_{y}*(x,y)+U_{z}(x,y)V_{z}*(x,y)) dA of two vector fields U, V with components Uₓ, U_{y}, U_{z} and Vₓ, V_{y}, V_{z}, respectively, in the directions x, y, z of a cartesian coordinate system and over the transverse area A that is typically the fiber cross-section.

The embodiments described herein may be applied to a vast number of combinations of different types and sizes of HCF and SCF. Both the HCF and SCF may be single-mode fiber or multimode fiber, and each may have one or several cores (e.g., single-core fiber or multicore fiber). Any combination is possible, such as a multimode multicore HCF and a single-mode SCF, a single-core multimode HCF and a multimode SCF, etc.

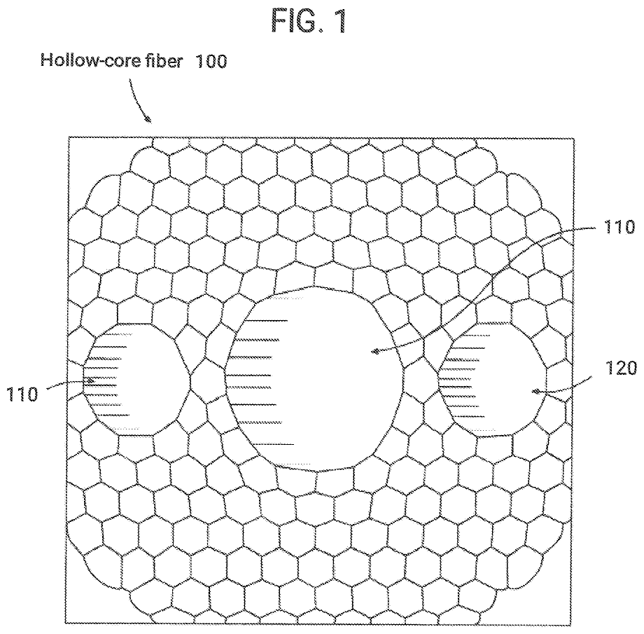

As an example of an HCF, FIG. 1 shows the cross-section of an exemplary HCF 100 with a cladding hole spacing of approximately 4.5 μm and a 19-cell center-core 110 with a core diameter of 23 μm. On the left and right of the center core, this HCF has two smaller 7-cell outer cores 120, often referred to as shunt cores, with a diameter of 13.6 μm. These outer cores 120 may be added to improve the transmission characteristics of the fiber. Alternative HCFs, to which the concepts of this invention can also be applied, may have a different number of smaller or larger shunt cores or no shunt cores at all.

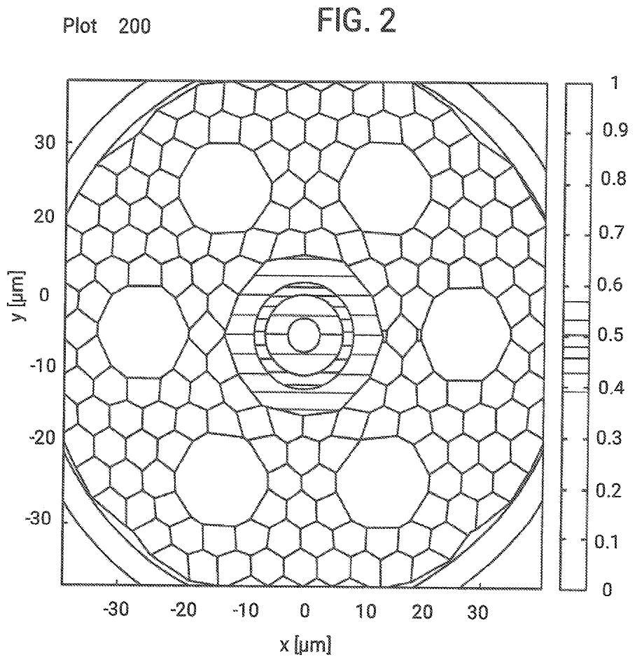

FIG. 2 is a plot 200 depicting the fundamental mode in an exemplary HCF with a 19-cell core 110 and with 6 outer cores 120 (shunts), in accordance with one embodiment of the present invention. To minimize the coupling loss, the fundamental mode of the SMF may have a relatively small overlap with the core wall region of the HCF. The arrows in the plot 200 indicate the local direction of the electric field, and the shading is proportional to the square root of the optical intensity. While the exemplary HCF used in FIG. 2 is a 19-cell HCF, alternative embodiments of the present invention are not limited to this structure and allow for variations to the HCF, using any number of cells and outer cores, including, but not limited to, the case of having no outer cores, i.e., a single-core HCF.

It is important to note that the direction of the electric (and magnetic) field of the fundamental mode of the HCF is strongly position-dependent in this core wall region of the HCF (see FIG. 2). In contrast, an exemplary SMF may typically have a fundamental mode with a more uniformly oriented electric (and magnetic) field. Such a reduced overlap with the core wall region is achieved if the SMF has an MFD that is smaller than the MFD of the HCF.

However, making the MFD of the SMF too small may also lead to an increase in the coupling loss. As an example, graph 300 of FIG. 3A shows the mode mismatch loss (splicing or coupling loss minus Fresnel reflection loss) from an SMF with a Gaussian mode shape to the HCF from FIG. 2. At a wavelength of 1550 nm, an exemplary minimum mode mismatch loss of 0.29 dB may be achieved by using an SMF with an MFD of about 15 μm. This is only about 83% of the MFD of the HCF, which is about 18 μm at 1550 nm (see graph 350 FIG. 3B). In contrast, if an SMF with an MFD of 18 μm at 1550 nm had been chosen (see the thick line in FIG. 3A), the mode mismatch loss would be about 0.5 dB, i.e., 0.21 dB higher than the optimum loss. According to one embodiment of the present invention, the MFD of an exemplary SMF may be no greater than 85% of an MFD of the exemplary HCF. According to alternative embodiments of the present invention, the MFD of an exemplary SMF may be no greater than 90% of an MFD of the exemplary HCF.

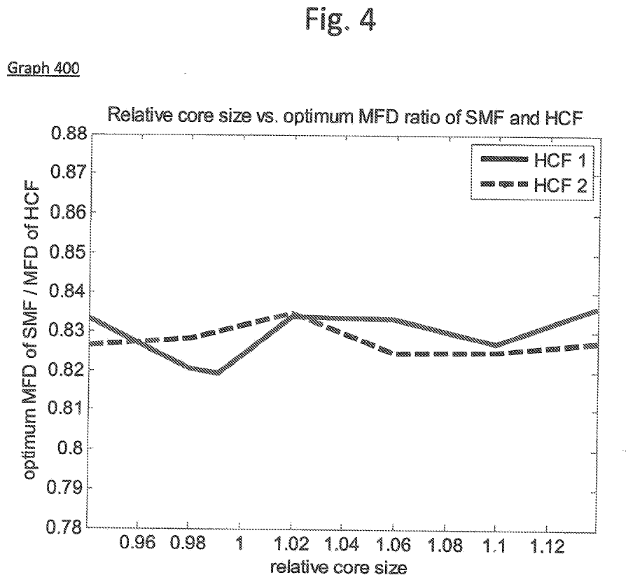

The fact that the optimum SMF MFD is significantly smaller than the MFD of the HCF holds over a large range of HCF core diameters and even different HCF designs. For example, graph 400 of FIG. 4 shows the optimum MFD ratio (optimum SMF MFD divided by MFD of the HCF) as a function of the relative core size d_{core,rel} of the HCF, which is defined as

$${d}_{core , rel} := \frac{{d}_{core}}{5 \cdot P}$$

with the absolute core diameter d_{core} and the pitch P of the microstructure, which, as those skilled in the art know, is the average diameter of the cells in the microstructure. The two fibers, HCF 1 and HCF 2, differ in a number of features, such as, for instance, air filling fraction, d_{core}, production date, etc. Nevertheless, in both cases, the optimum MFD ratio is consistently around 83%. For other HCF designs and/or SCF designs, the optimum ratio (of SCF MFD divided by HCF MFD) may be different from 83%, e.g., a value between 80% and 85%, or between 70% and 90%, or between 60% and 95%, or between 50% and 99%.

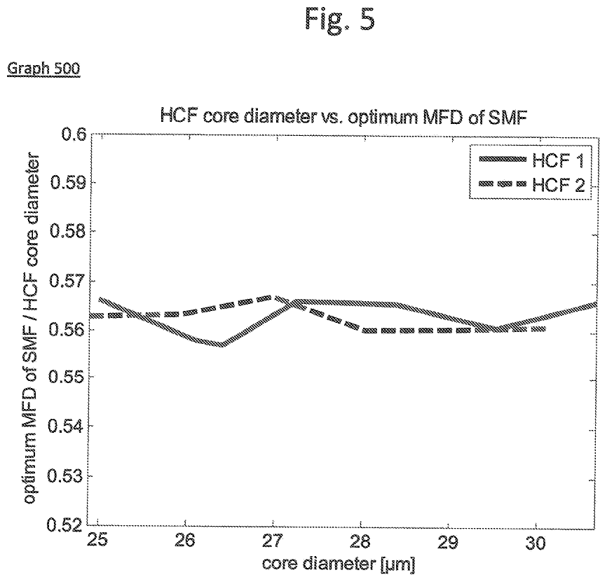

Accordingly, FIG. 4 normalizes the optimum MFD of the SMF in terms of a modal property of the HCF, namely its MFD, which may be hard to measure. In addition, FIG. 5 normalizes in terms of the much easier to measure core diameter of the HCF. The graph 500 in FIG. 5 illustrates the relationship between the SMF MFD and the HCF core diameter. In these units, the optimum MFD of the SMF is about 56% of the core diameter of the HCF, again over a large range of HCF core diameters and for both HCF 1 and HCF 2. In other words, the optimum MFD of the SCF may only be a little more than half the diameter of the core of the HCF. According to one embodiment of the present invention, the MFD of an exemplary SMF may be no greater than 58% of the core diameter of an exemplary HCF. According to an alternative embodiment of the present invention, the MFD of an exemplary SMF may be no greater than 61% of the core diameter of an exemplary HCF. For other HCF designs and/or SCF designs, the optimum ratio (of SCF MFD divided by HCF core diameter) may be different from 56%, e.g., a value between 50% and 60%, or between 40% and 70%, or between 30% and 80%, or between 20% and 90%.

If the HCF has a large core, e.g., a diameter of 25 μm or more, that can be advantageous to reduce the propagation loss along the HCF section, the MFD of an available SCF may be less than the optimum. For instance, the optimum MFD may be 56% of the core diameter of the HCF, but the largest available SCF may have an MFD of only 40% of the core diameter of the HCF. In such a case, it may be advantageous to add a “bridge” fiber between the HCF and the SCF, where the MFD of the bridge fiber is larger than the MFD of the available SCF but smaller than the optimum MFD. In said example with an available ratio of 40% and a target ratio of 56%, a bridge fiber with an intermediate MFD of, e.g., 48% of the HCF core diameter may lower the overall coupling loss in comparison to the case without a bridge fiber.

If the HCF has a small core, e.g., a diameter of 20 μm or less, that can be advantageous to reduce the number of unwanted higher order modes, the MFD of an available SCF may be larger than the optimum. For instance, the optimum MFD may be 56% of the core diameter of the HCF, but the smallest available SCF may have an MFD of 72% of the core diameter of the HCF. In such a case, it may also be advantageous to add a “bridge” fiber between the HCF and the SCF, where the MFD of the bridge fiber is smaller than the MFD of the available SCF but larger than the optimum MFD. In the above example with an available ratio of 70% and a target ratio of 56%, a bridge fiber with an intermediate MFD of, e.g., 63% of the HCF core diameter may lower the overall coupling loss in comparison to the case without a bridge fiber.

As noted above, it may be advantageous to use a third fiber (typically a short section) between an exemplary SMF and an exemplary HCF in order to further reduce the coupling loss or splicing loss. Thus, a single change of the MFD may be replaced by two smaller changes in the MFD. More generally, one or more fibers or waveguides (typically short sections) may be used between the SMF and the HCF to achieve an even more gradual change of the MFD. According to an alternative embodiment, a taper may be used with a continuous variation of the MFD along its length. Such a longitudinally varying MFD may also be achieved with a thermally expanded core (TEC) fiber or a splice to a small-form-factor (SFF) fiber.

To further reduce the mode mismatch and splicing or coupling loss, various dopants and doping profiles (e.g., varying refractive indices) may be used at the tip of the exemplary SMF, and/or gases, liquids, or solids may be included in the core or cores or cladding cells of the exemplary HCF. Furthermore, according to an alternative embodiment of the present disclosure, there may be an angled splice between the HCF and SCF to reduce unwanted backreflections, often referred to as reflectance. In general, an angled splice may direct the reflected light in a direction other than traveling back along a fiber. Furthermore, the reflectance may decrease significantly. However, the insertion loss may not be expected to decrease by using an angled splice. In some embodiments, the insertion loss may even increase with an angled splice while the return loss decreases.

An exemplary angled splice may be located anywhere between the HCF and the SCF, such as but not limited to, between the HCF and a bridge fiber, between the bridge fiber and the SCF, between the HCF and the TEC fiber, between the HCF and the SFF fiber, etc. Furthermore, it is noted that an exemplary angled splice may be within the range of 0° to 15°, preferable from 1° to 8° or from 1° to 4°. For instance, according to one embodiment, a splice angle of 8° may attenuate the reflected light by at least 100 dB. A return loss that does not impair the optical system that includes the fiber will likely not need 100 dB but may need only 20 dB, in which case the angled splice may feature a shallower angle (e.g., 3° or 4°). The difficulty in maintaining a low transmission loss through the angle splice may increase with the angle required.

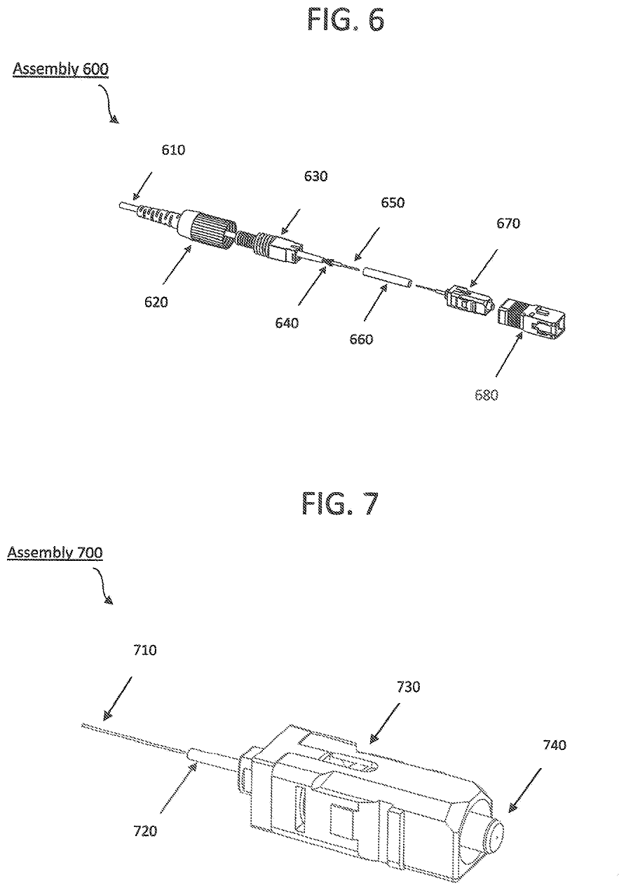

Additional embodiments of the present invention pertain to the design of novel optical connector assemblies that provide a quick and easy field termination of HCF. These new optical connector assemblies may be used to produce low latency patchcords. For optimal optical performance and installation speed, these new connector assemblies are configured as fusion splice-on connectors (SOCs). For simplicity, herein, the inventions are presented as SC-type connectors, but it should be understood that other connector configurations (e.g., LC, MU, FC, MPO [with standard through-hole MT ferrules or lensed multifiber ferrules], and other simplex or multifiber variants) are also feasible and included. FIG. 6 is an exploded view of an exemplary assembly 600 for an HCF termination using SOC. Configured as an SC-type connector, as depicted in FIG. 6, these new connector assemblies will consist of a grip 680, connector plug assembly 670, splice protector 660, cable retention member 630, and cable support assembly 620. The assembly 600 also includes the HCF cable 610, an aramid yard 640, and the HCF 650.

FIG. 7 shows a close-up of an SOC plug assembly 700, such as, for instance, connector plug assembly 670. The connector plug assembly 700 may include a novel fiber stub 710, a buffer tubing 720, a plug housing 730, and a ferrule 740. According to exemplary embodiments described herein, the novel fiber stub 710 of the connector plug assembly 700 may be polished at the ferrule 740 and pre-cleaved at the distal end. One of the advantages of using the exemplary SOC plug assembly 700 as opposed to conventional components (e.g., a pigtail) is the robustness and versatility of SOC plug designs. For instance, an SOC may be sized and designed to be attached to an aramid of a cable and therefore have improved mechanical strength.

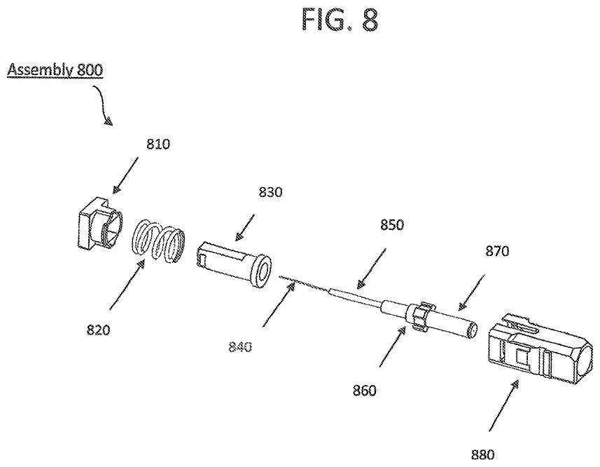

FIG. 8 shows an exploded view of an SOC plug assembly 800, such as, for instance, connector plug assembly 670. The exemplary connector plug assembly 800 may include a plug housing 880, ferrule 870, ferrule flange 860, buffer tubing 850, novel fiber stub 840, spring push 830, a spring 820, and a retainer 810 that snaps into the rear of the plug housing 880 to capture the other components.

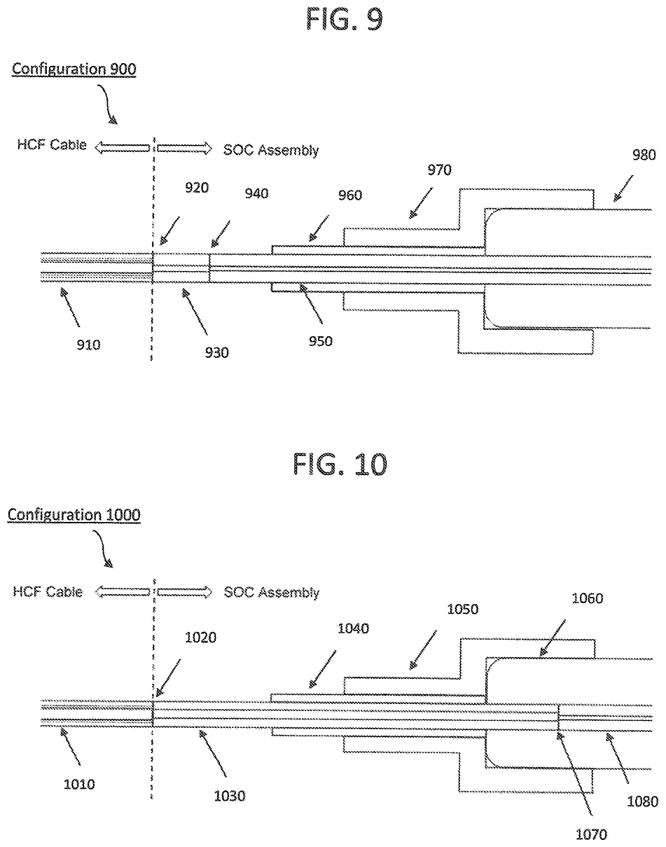

FIG. 9 shows an SCF-to-ultra large area fiber (ULA)-to-HCF configuration 900 after SOC installation. The exemplary configuration 900 features an HCF 910, a ULA 930 with splice joints 920 and 940, an SCF 950, a buffer tubing 960, a ferrule flange 970, and a ferrule 980. The SOC assembly depicted in FIG. 9 is configured with a fiber stub consisting of the SCF 950 within the polished ferrule and a pre-cleaved distal end consisting of a short length of ULA 930 spliced as a “bridge” fiber to the end of the SCF 950 exiting the buffer tubing 960. As described above, the ULA fiber 930 is selected such that its MFD is smaller than the optimum SCF MFD for the given HCF, but larger than the MFD of the present SCF, to minimize loss due to MFD mismatch. Specifically, to ensure low loss when terminating the HCF 910, the effective area of the ULA fiber 930 should be between 50 μm² and 1000 μm², and, even more specifically, between 100 μm² and 400 μm², and, even more specifically, between 115 μm² and 200 μm². Once the connector is fusion-spliced to the HCF 910 in the field, the ULA 930 serves as a “bridge” between the HCF 910 and SCF 950.

For instance, for an HCF with a core diameter of 25 μm, the optimum MFD of an SCF may be approximately 14 μm, while the available SCF may have an MFD of only approximately 10 μm. In this case, a ULA with an MFD of, e.g., 12 μm could be selected. Once the field splice has been performed, the splice is protected using a small splice protector. The remaining connector components (e.g., cable retention member 630, cable support assembly 620, and grip 680) may then be attached to complete the assembly and thus, further protect a splice joint.

FIG. 10 shows an SCF-to-ULA-to-HCF configuration 1000 after SOC installation with SCF-to-ULA splice 1070 located inside a ferrule 1060. As depicted in FIG. 10, the SOC assembly is configured with a length of SCF 1080 positioned within the polished ferrule 1060 and a pre-cleaved distal end consisting of a length of ULA fiber 1030 spliced (at splice joint 1070) as a bridge fiber to the end of the SCF 1080 positioned within the ferrule 1060. The configuration is achieved by fusion splicing a length of the SCF 1080 to a length of the ULA fiber 1030, injecting epoxy into the ferrule 1060, inserting the spliced fiber into the ferrule 1060 until the splice joint 1070 is positioned within the ferrule 1060. Next, the epoxy is cured. Then the SCF 1080 exiting the end face of the ferrule 1060 is cleaved and polished. Subsequently, the ULA fiber 1030 is cleaved to form the pre-cleaved fiber stub. The ULA fiber 1030 is selected such that its MFD is smaller than the optimum SCF MFD for the given HCF 1010, but larger than the MFD of the present SCF 1080, to minimize loss due to MFD mismatch. Specifically, to ensure low loss when terminating HCF at splice joint 1020, the effective area of the ULA fiber 1030 should be between 50 μm² and 1000 μm², and, even more specifically, between 100 μm² and 400 μm², and, even more specifically, between 115 μm² and 200 μm². Once the connector is fusion-spliced to the HCF 1010 in the field, the ULA fiber 1030 serves as a “bridge” between the HCF 1010 and the SCF 1080.

For instance, for an HCF with a core diameter of 25 μm, the optimum MFD of an SCF may be approximately 14 μm, while the available SCF may have an MFD of only approximately 10 μm. In this case, a ULA fiber with an MFD of, e.g., 12 μm could be selected. Once the field splice has been performed, the splice is protected using a small splice protector. The remaining connector components (e.g., cable retention member 630, cable support assembly 620, and grip 680) may then be attached to complete the assembly and thus, further protect a splice joint. This configuration 1000 reduces the splicing points from two to one inside the splice protector 660, increases the robustness of the assembly, and eases the assembly process. Furthermore, the exemplary configuration 1000 may include a buffer tubing 1040 and a ferrule flange 1050 in communication with the ferrule 1060.

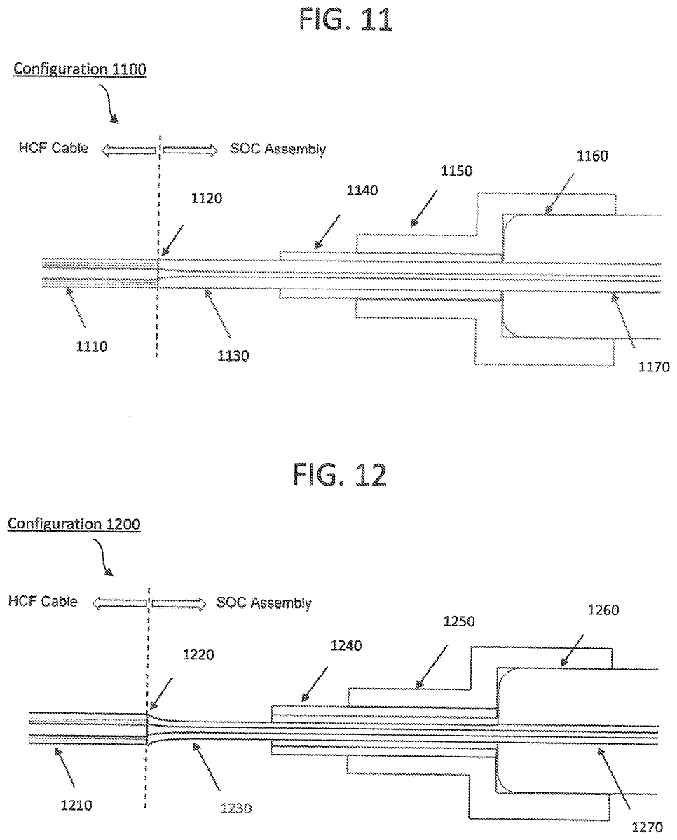

FIG. 11 shows an HCF-to-thermally expanded core (TEC) fiber configuration 1100 after SOC installation. As depicted in FIG. 11, the SOC assembly is configured with a fiber stub consisting of a length of a thermally expanded core (TEC) fiber 1170. The exemplary TEC fiber 1170 may feature an expanded-core end 1130 that increases the MFD of a portion of the TEC fiber 1170 for improved coupling. For instance, the TEC fiber 1170 may be produced by heating a conventional SMF on one end (1130) to expand the core size over a portion of the TEC fiber 1170 (e.g., 2.5 mm length). Accordingly, this expanded-core end 1130 allows the TEC fiber 1170 to accept light having a larger MFD while retaining the single mode and optical properties of the fiber 1170. While thermal diffusion may change the refractive index profile of the TEC fiber 1170, the normal frequency does not change, and hence the single-mode condition is maintained through the expansion process.

According to one exemplary embodiment of the present invention, the expanded-core end 1130 of the TEC fiber 1170 forms the pre-cleaved distal end spliced to the HCF 1110 at splice joint 1120. The opposing end of the TEC fiber 1170 is within the polished ferrule 1160 of the SOC. This opposing end has an MFD selected to be equal or close to the MFD of another SCF within an opposing connector, in the link, to which the SOC will ultimately be mated. The TEC fiber 1170 is selected such that its MFD, at the expanded-core end, is equal or close to the MFD of the optimum SCF, to minimize loss.

For instance, for an HCF with a core diameter of 30 μm, the optimum MFD of an SCF may be approximately 17 μm, while the available SCF may have an MFD of only approximately 10 μm. In this case, a TEC fiber with an MFD, at the expanded-core end, of, e.g., 15 μm to 18 μm, e.g., close to the optimum MFD, could be selected. Even if the MFD of the TEC at its expanded-core end is larger than the optimum MFD (e.g., 18 μm instead of an optimum 17 μm), the overall loss may still be lower than in the absence of a bridge fiber. More generally, TEC fibers with nominal MFDs (at the expanded core end) ranging from 12 μm to 20 μm, and even more generally with nominal MFDs from 10 μm to 30 μm, and even more generally with MFDs from 5 μm to 50 μm, should be utilized to optimize optical performance. According to one embodiment, the core of an exemplary TEC fiber may be expanded such that the MFD at the proximal end of the TEC fiber is at least 40% greater than the MFD at the distal end of the TEC fiber.

The TEC fiber 1170 will allow low-loss transmission from the HCF 1100 to the SCF 1170. Once the field splice has been performed, the splice is protected using a small splice protector 660. Furthermore, the exemplary configuration 1100 may include a buffer tubing 1140 and a ferrule flange 1150 in communication with the ferrule 1160. The remaining connector components (e.g., cable retention member 630, cable support assembly 620, and grip 680) may then be attached to complete the assembly and thus, further protect a splice joint.

FIG. 12 shows an HCF-to-small-form-factor fiber (SFF) fiber configuration 1200 after SOC installation. As depicted in FIG. 12, the SOC assembly is configured with a fiber stub consisting of an SFF fiber 1230 within the polished ferrule 1260 and a pre-cleaved distal end. The outside diameter (OD) of the SFF 1230 is selected such that when it is spliced to an HCF 1210 at splice joint 1220, the difference in fiber cladding diameters causes expansion of the core of the SFF fiber 1230, as depicted in FIG. 12. An exemplary SFF fiber 1230 may refer to any of several physically compact fiber designs utilized within an SFF connector of a fiber optic system. Such SFF connectors featuring the SFF fiber 1230 may be smaller than (e.g., half the size of) conventional connectors.

For example, splicing an SFF fiber with an OD of 80 μm to a fiber with an OD of 125 μm can precipitate a significant core expansion in the SFF fiber. The SFF fiber with nominal cladding diameters ranging from 70 μm to 100 μm, or more generally from 60 μm to 110 μm, or even more generally from 50 μm to 120 μm may be utilized to achieve the desired post-splice core expansion. According to one embodiment, the core of an exemplary SFF fiber may be expanded such that the MFD at the proximal end of the SFF fiber is at least 40% greater than the MFD at the distal end of the SFF fiber.

The exemplary SFF 1230 with the newly expanded core will allow low loss transmission from the HCF 1210 to the SCF 1230. Once the field splice has been performed, the splice is protected using a small splice protector 660. Furthermore, the exemplary configuration 1200 may include a buffer tubing 1240 and a ferrule flange 1250 in communication with the ferrule 1260. The remaining connector components (e.g., cable retention member 630, cable support assembly 620, and grip 680) may then be attached to complete the assembly and thus, further protect a splice joint.

While the configurations presented herein embody SC-type connectors, as noted above, other connector configurations (i.e., LC, MU, FC, MPO [with standard through-hole MT ferrules or lensed multifiber ferrules], and other simplex or multifiber variants) are feasible and may be utilized without departing from the spirit and scope of the inventions and that the inventions include such variants. Also, connector configurations presented herein are suitable for termination of jacketed cable with aramid-yarn strength members, but the exemplary embodiments described herein may also be applied to other cabled fiber configurations like buffered fibers, ribbonized fibers, rollable ribbons, etc.

It may also be advantageous to use two or more bridge fibers between the SCF and the HCF, e.g., to reduce the maximum differences between the MFDs of adjacent fiber ends especially if the MFD of the HCF and the MFD of the SCF differ by a large amount.

The exemplary embodiments described throughout this specification are not only applicable to HCFs but may also be applied to other types of microstructured fibers as well as more generally to fibers with a fundamental mode that has a transverse shape that is different from the transverse shape of the fundamental mode of a typical SMF. In particular, the coupling loss between a common SCF and such a different fiber may be minimized by choosing an SCF with an MFD that is significantly smaller than the MFD of the different fiber. Specifically, the coupling loss may be minimized if the fundamental mode of said different fiber has a transverse intensity profile that does not decrease monotonically in a radial direction (i.e., away from the optical axis that is usually the symmetry axis of the fiber), and/or if spatial variations of the direction or phase of the electric field vector of the fundamental mode of said different fiber are less pronounced near the optical axis than further away from the optical axis. In these cases, a significantly smaller MFD of the SCF would reduce the overlap of the fundamental mode of the SCF with the outer radial region of the different fiber where its fundamental mode profile differs significantly from the fundamental mode profile of the SCF.

Further aspects of the present invention relate to methods for reducing the coupling loss or splicing loss between optical fibers, such as an exemplary HCF and an SMF. These exemplary methods may include, but are not limited to: coupling/splicing an exemplary HCF to an exemplary SMF with significantly smaller MFD; coupling/splicing an HCF to an SMF by inserting a third fiber with an MFD that is between the MFD of the HCF and the MFD of the SMF; coupling/splicing an HCF to an SMF that is tapered at its end; coupling/splicing an HCF to an SMF that may have a longitudinally varying concentration of dopants at its end, longitudinally varying the refractive index at its end, etc.

Throughout this specification, the term “SMF” may refer to a solid-core SMF. However, those skilled in the art would understand that SMF may also refer to a different type of SMF, such as for example, a hollow core single mode fiber.

The present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. An article of manufacture configured to reduce a coupling loss between multiple optical fibers, including:
a hollow-core fiber (HCF) having a first mode field diameter (MFD);
a solid core fiber (SCF) having a second MFD that is no greater than 90% of the first MFD; and
a splice-on-connector (SOC) assembly including a bridge fiber spliced between the HCF and the SCF, wherein the bridge fiber has a third MFD that is greater than the second MFD and smaller than the first MFD.

2. The article of manufacture described in claim 1, wherein the SOC features an angled splice between the HCF and SCF to decrease the reflectance.

3. The article of manufacture described in claim 2, wherein the angled splice features an angle within a range from 0° to 15° between hollow-core fiber (HCF) and bridge fiber.

4. The article of manufacture described in claim 1, wherein the bridge fiber is an ultra-large area (ULA) fiber featuring an effective area between 50 μm² and 1000 μm².

5. The article of manufacture described in claim 1, wherein the SCF has a fundamental MFD that is no greater than 61% of a diameter of a core wall region of the HCF.

6. The article of manufacture described in claim 1, wherein the splice between the bridge fiber and the SCF is located within a ferrule of the SOC.

7. The article of manufacture described in claim 1, wherein the SCF is a single-mode fiber.

8. An article of manufacture configured to reduce a coupling loss between multiple optical fibers, including:
an HCF having a first MFD; and
an SCF having a proximal end spliced to the HCF and a distal end, the SCF further having a second MFD at the proximal end and a third MFD at the distal end, wherein the second MFD is greater than the third MFD, and the third MFD is no greater than 90% of the first MFD.

9. The article of manufacture described in claim 8, wherein the SCF is a thermally-expanded core (TEC) fiber.

10. The article of manufacture described in claim 8, wherein the SCF is a small-form-factor (SFF) fiber featuring an expandable cladding end at the proximal end spliced to the HCF and a fixed cladding end at the distal end.

11. The article of manufacture described in claim 8, wherein the splice at the proximal end of the SCF features an angled splice to decrease the reflectance.

12. The article of manufacture described in claim 11, wherein the angled splice features an angle within a range from 0° to 15° between hollow-core fiber (HCF) and bridge fiber.

13. The article of manufacture described in claim 8, wherein the SCF has a fundamental MFD that is no greater than 61% of a diameter of a core wall region of the HCF.

14. The article of manufacture described in claim 8, wherein the second MFD at the proximal end of the SCF is at least 40% greater than the third MFD at the distal end of the SCF.

15. The article of manufacture described in claim 8, wherein the SCF is a single-mode fiber.

16. A method of configuring an article to reduce a coupling loss between multiple optical fibers, including:
coupling an HCF having a first MFD to an SCF fiber, wherein the SCF has a proximal end spliced to the HCF and a distal end, the SCF further having a second MFD at the proximal end and a third MFD at the distal end, wherein the second MFD is greater than the third MFD, and the third MFD is no greater than 90% of the first MFD.

17. The method described in claim 16, further including:
thermally expanding a core within the SCF such that the second MFD at the proximal end of the SCF is at least 40% greater than the third MFD at the distal end of the SCF.

18. The method described in claim 16, wherein the SCF is an SFF fiber featuring an expandable cladding end at the proximal end spliced to the HCF and a fixed cladding end at the distal end.

19. The method described in claim 16, wherein the splice at the proximal end of the SCF features an angled splice within a range from 0° to 15° to decrease the reflectance.

20. The method described in claim 16, wherein the SCF has a fundamental MFD that is no greater than 61% of a diameter of a core wall region of the HCF.
